(19) United States
(12) Patent Application Publication
(10) Pub. No.: US 2025/0198937 A1
(43) Pub. Date: Jun. 19, 2025

(54) METHODS, DEVICES, AND SYSTEMS FOR MEASURING A CONCENTRATION OF AN AMINE-BASED COMPOUND IN AN ETCHING SOLUTION

(71) Applicant: ENTEGRIS, INC., Billerica, MA (US)

(72) Inventors: Hsin Hua Wu, Hsinchu County/Zhudong (TW); Joseph Evans, Oak Park, IL (US); Porter K. Lewis, Tempe, AZ (US)

(21) Appl. No.: 18/967,605

(22) Filed: Dec. 3, 2024

Related U.S. Application Data
(60) Provisional application No. 63/611,604, filed on Dec. 18, 2023.

(51) Int. Cl. G01N 21/78; G01N 21/77

(52) U.S. Cl. CPC G01N 21/78; G01N 2021/7786

(57) ABSTRACT

Described are methods of measuring a concentration of a photosensitive group in a liquid, for example a concentration of amine-based inhibitor in an etching solution, and related equipment and systems.

### FIELD

The invention relates to methods of measuring an amount of amine-based compound in an etching solution and related equipment and methods.

### BACKGROUND

Silicon nitride is used in the microelectronics manufacturing industry, including as a hard mask layer used to prepare high aspect ratio structures included in solid state 3D NAND memory devices. According to this exemplary use, silicon nitride layers act as sacrificial layers between silicon oxide layers. The silicon nitride layers are removed by etching to leave a space between two silicon oxide layers.

Certain types of silicon nitride etch processes use a liquid etching bath and a liquid etching solution that contains hot phosphoric acid. The hot phosphoric acid can be used to effectively remove silicon nitride with a high etch rate and with high selectivity relative to silicon oxide also present at a substrate surface.

A typical etching solution is primarily an aqueous phosphoric acid solution combined with minor amounts of one or more dissolved ingredients that improve etching performance. An example of a minor ingredient is a dissolved silicate compound, which improves a rate and selectivity of etching silicon nitride. As another example, an etching solution may contain dissolved amine-containing or “amine-based compound” to improve an etching rate and selectivity of silicon nitride.

To achieve consistent and predictable outcomes of a silicon nitride wet etching step, the amounts of dissolved minor ingredients in an etching solution that affect etching rate or selectivity are selected to produce a desired etching rate and selectivity of silicon nitride. An amount of one of these dissolved ingredients in an etching solution is an important operating parameter and is gradually reduced during use of the etching solution. If a concentration of such an ingredient becomes too low, an etching solution does not function as needed and the quality and yield of etched substrates will suffer.

Accordingly, silicon nitride etching solutions can have useful lifetimes based on their diminishing concentration of a dissolved ingredient such as amine-based inhibitor or silica compound. Such ingredients are gradually depleted from the etching solution during use and etching solutions that contain one of these ingredients are periodically replaced or replenished. The timing of replacing or replenishing the etching solution is designed to keep a concentration of one of these dissolved ingredients at a useful level. For example, an etching solution may be replaced or replenished after a predetermined amount of use, such as after a predetermined amount time (e.g., days) during which the etching solution is used, or after a predetermined number of wafers are processed in an etching solution.

In either instance the method suffers an implicit inefficiency because an etching solution replaced on either basis may still contain a useful amount of the dissolved ingredient (e.g., amine-based inhibitor or dissolved silica) and if so the etching solution is replaced before reaching an end of its useful life.

### SUMMARY

The microelectronic manufacturing industry requires ever-better methods to control the efficiency and cost of manufacturing microelectronic devices. In a silicon nitride etching process there is an opportunity to reduce the overall cost of these etching processes by reducing the inefficiencies inherent in methods that replace an etching solution at an estimated end of life that is assessed by tracking an amount of use of the etching solution.

Described as follows are improved methods of determining when a silicon nitride etching solution has reached an end of its useful lifetime due to an undesirably low concentration of a dissolved amine-based inhibitor. According to example methods, an end of a useful life of an etching solution is assessed by directly measuring a concentration of amine-based inhibitor in a sample taken from an etching solution being used in a wet-etching process. If a measured concentration of amine-based inhibitor in an etching solution is too low (e.g., below a predetermined or desired minimum level) the etching solution of the wet-etching process can be replaced or replenished.

According to example methods and systems, a method of measuring an amount of an amine-based inhibitor in an etching solution may be performed in a manner that is efficient, accurate, and preferably automated. An automated method may be performed with a system that is operatively connected to a silicon nitride wet-etching apparatus using steps that include: obtaining an etching solution sample from a silicon nitride etching bath, forming a test solution from the etching solution sample, and analyzing the test solution using a spectroscopy technique to determine a concentration of the amine-based inhibitor in the etching solution sample.

According to example methods, a concentration of amine-based inhibitor in an etching solution can be assessed analytically by first chemically converting amine groups of amine-based inhibitor molecules into a photosensitive group (“photosensitive cyclic amine complex”). The amine-based inhibitor molecule that has the photosensitive groups derived from the amine is referred to as a “photosensitive inhibitor complex.” After converting the amine-based inhibitor to form the photosensitive inhibitor complex, the concentration of the photosensitive inhibitor complex is in the test solution is measured using a spectroscopy method. The concentration of the photosensitive inhibitor complex in the test solution can be correlated to a concentration of the amine-based inhibitor in the etching solution sample.

The following description includes specific examples of methods that are used to measure a concentration of amine-based inhibitor in a silicon nitride etching solution during use of the etching solution in a wet-etching process, while the etching solution is at an elevated temperature. While not specified as examples, the following described methods may alternately be useful for measuring a concentration of amine-based inhibitor in a silicon nitride etching solution at a different time or at a lower temperature, such as before the etching solution is used in a wet-etching process. Accordingly, a concentration of amine-based inhibitor in a silicon nitride etching solution may be measured before the etching solution is used in a wet-etching process, while the etching solution is at room temperature.

In one aspect, the invention relates to method for determining a concentration of amine-based inhibitor in a silicon nitride etching solution. The method includes: preparing a test solution comprising silicon nitride etching solution, complexing agent, and water, the silicon nitride etching solution comprising phosphoric acid and amine-based inhibitor; allowing the complexing agent to react with an amine group of the amine-based inhibitor to form a photosensitive inhibitor complex; using spectroscopy to determine a concentration of the photosensitive inhibitor complex in the test solution; and from the concentration of the photosensitive inhibitor complex in the test solution, determining a concentration of the amine-based inhibitor in the etching solution.

In another aspect, the invention relates to an automated fluid monitoring system adapted to monitor a concentration of amine-based inhibitor in an etching solution. The system includes: (a) a sampling system adapted to obtain an etching solution sample from a silicon nitride wet-etching apparatus that includes a silicon nitride etching bath; (b) a reservoir of deionized water; (c) a reservoir of pH buffer solution; (d) a reservoir of complexing agent; (e) a mixing chamber adapted to prepare a test solution comprising at least a portion of the etching solution sample, deionized water, pH buffer, and complexing agent, and to allow the complexing agent to react with an amine group of amine-based inhibitor contained in the etching solution sample to form a photosensitive inhibitor complex; (f) a spectrometer adapted to receive the test solution from the mixing chamber and measure a concentration of photosensitive inhibitor complex in the test solution; and (g) a control system adapted to determine a concentration of amine-based inhibitor in the etching solution sample based on the concentration of photosensitive inhibitor complex in the test solution.

In yet another aspect, the invention relates to a method of determining a concentration of amine-based inhibitor contained in a liquid. The method includes: forming a photosensitive group from an amine group of amine-based inhibitor in a liquid; and using a spectroscopy method to measure a concentration of the amine-based inhibitor having the photosensitive group, in the liquid.

In yet another aspect, the invention relates to a method of forming a photosensitive compound in a liquid. The method includes: preparing a solution comprising phosphoric acid, amine-based inhibitor comprising an amine group, complexing agent, and water; and allowing the complexing agent to react with the amine group to form a photosensitive inhibitor complex.

### BRIEF DESCRIPTION OF THE DRAWINGS

FIG. 1 shows steps of an example process as described.

FIG. 2 is a schematic illustration of example components and a system for measuring concentration of an amine-based inhibitor in a silicon nitride etching solution.

### DETAILED DESCRIPTION

The following description relates to methods for measuring an amount of an amine-based inhibitor that is present in a silicon nitride wet-etching solution (or “etching solution” for short). The methods and related systems and equipment can be used to quantitatively measure an amount of an amine-based inhibitor in an etching solution, preferably using an automated system that measures a concentration of the amine-based inhibitor in an etching solution etching as the etching solution is being used to perform a wet-etching process.

The method may be performed using an automated measurement system, with equipment that is connected to an etching apparatus, and during an etching operation, i.e., as the etching solution is being used in a wet-etching operation. Example steps of a method of measuring the concentration of amine-based inhibitor in an etching solution may include: obtaining an etching solution sample from a silicon nitride etching bath; combining the etching solution sample with other ingredients that include water, to form a test solution that can be analyzed using a spectroscopy method; and analyzing the test solution using a spectroscopy method to measure a concentration of a solute in the test solution. The measured concentration of the solute in the test solution can be correlated to a concentration of amine-based inhibitor in the etching solution sample. The spectroscopy step may be based on absorption spectroscopy, fluorescence spectroscopy, or both.

Other techniques used to maintain a useful concentration of amine-based inhibitor in an etching solution do not measure or monitor a concentration of the amine-based inhibitor in the etching solution. Instead, previous methods rely on preventing a concentration of the amine-based inhibitor from becoming undesirably low during use of the etching solution by tracking an amount of use of the etching solution and replacing or replenishing the etching solution after a predetermined amount of time of use of the etching solution or after a predetermined number of wafers have been processed in the etching solution. Either method causes the etching solution to be replaced before otherwise necessary and results in increased cost by not using the etching solution to full capacity.

In contrast to previous methods, methods as described use a quantitative measurement of a concentration of amine-based inhibitor in an etching solution to more precisely determine an end of a useful lifetime of the etching solution. A quantitative assessment of the concentration of amine-based inhibitor in the etching solution and an end of a useful lifetime of the etching solution will improve the efficiency of using the expensive etching solution and produce less waste by not replacing the etching solution too early.

A method of the present description can be used with wet-etching operations for processing silicon nitride layers. In example applications, silicon nitride is used as a hard mask layer for preparing high aspect ratio structures included in solid state logic devices and memory devices such as 3D NAND memory devices, in front end of line or back end of line processes. Multiple silicon nitride layers are formed as sacrificial layers between silicon oxide layers. The silicon nitride layers are removed by a silicon nitride etching step to leave a space between two silicon oxide layers.

The term “microelectronic device” (or “microelectronic device substrate,” or simply “substrate”) is used herein in a manner that is consistent with the generally understood meaning of this term in the electronics, microelectronics, and semiconductor fabrication arts, for example to refer to any of a variety of different types of: semiconductor substrates; integrated circuits; solid state memory devices; hard memory disks; read, write, and read-write heads and mechanical or electronic components thereof; flat panel displays; phase change memory devices; solar panels and other products that include one or more solar cell devices; photovoltaics; and microelectromechanical systems (MEMS) manufactured for use in microelectronic, integrated circuit, energy collection, or computer chip applications. It is to be understood that the term “microelectronic device” can refer to any in-process microelectronic device or microelectronic device substrate that contains or is being prepared to contain functional electronic (electrical-current-carrying) structures, functional semiconductor structures, and insulating structures, for eventual electronic used in a microelectronic device or microelectronic assembly.

As used herein, the term “silicon nitride” is given a meaning that is consistent with the meaning of the term as used in the microelectronics and semiconductor fabrication industries. Consistent therewith, silicon nitride refers to materials including thin films made of amorphous silicon nitride (Si₃N₄), e.g., deposited by chemical vapor deposition from silane (SiH₄) and ammonia (NH₃), with commercially useful low levels of other materials or impurities. The silicon nitride may be present as part of a microelectronic device substrate as a functioning feature of the device, for example as a barrier layer or an insulating layer, or may be present to function as a material that facilitates a multi-step fabrication method for preparing a microelectronic device.

As used herein, the term “silicon oxide” is given a meaning that is consistent with the meaning of the term as used in the microelectronics and semiconductor fabrication industries. Consistent therewith, silicon oxide refers to thin films made of silicon oxide (SiOₓ), e.g., SiO₂, “thermal oxide” (ThOₓ), and the like.

According to certain commercial methods, silicon nitride is removed from a microelectronic device surface by a wet etching process that involves exposing the substrate surface to phosphoric acid (H₃PO₄) at an elevated temperature, e.g., in an etching bath having a temperature in a range from 150 to 180 degrees Celsius.

Conventional wet etching techniques for selectively removing silicon nitride relative to silicon oxide have used aqueous phosphoric acid (H₃PO₄) solutions as etching solutions. The etching solution includes aqueous phosphoric acid (e.g., concentrated phosphoric acid) in an amount that is effective to produce desired etching of silicon nitride. The term “aqueous phosphoric acid” refers to an ingredient of the etching solution that is combined with other ingredients of the etching solution to form the etching solution. The term “phosphoric acid solids” refers to the non-aqueous component of an aqueous phosphoric acid ingredient, or that is a component of an etching solution that is prepared from aqueous phosphoric acid ingredient.

The amount of phosphoric acid solids contained in an etching solution can be an amount that in combination with the other ingredients of an etching solution will provide desired etching performance, including desired silicon nitride etch rate and selectivity, which typically requires a relatively high amount (concentration) of phosphoric acid solids. For example, an etching solution can contain an amount of phosphoric acid solids that is at least about 50 weight percent based on total weight of the etching solution, e.g., at least 70, or at least about 80 or 85 weight percent phosphoric acid solids based on total weight of the etching solution. Example etching solutions may contain at least 60, e.g., at least 80 or at least 90, 93, 95, or at least 98 weight percent concentrated phosphoric acid, based on total weight etching solution.

Silicon nitride etching processes are designed to produce a combination of a high etch rate of silicon nitride and a high selectivity of silicon nitride relative to silicon oxide. In addition to phosphoric acid, other ingredients can be included in an etching solution to produce a desired selectivity and silicon nitride etch rate. One such ingredient is an amine-based compound, sometimes, referred to herein as an “amine-based inhibitor.”

Examples of amine-based inhibitors include aminoalkyl alkoxy silane, or “amino alkoxy silane” for short, which, as these terms are used herein, refers to a silane (—SiO—)-based compound or molecule that contains at least one silicon atom and at least one amine group located on an alkyl or an alkoxy substituent of the compound, i.e., an aminoalkyl substituent connected to the silicon atom either directly or through an oxygen linkage. The silicon atom can be substituted with one or more such aminoalkyl substituents and can be substituted additionally with one or more: hydroxide (—OH) group, organic chemical (e.g., alkyl) groups, or another silicon atom through an oxygen to form a siloxane linkage, i.e., to form a molecule having multiple (e.g., 2, 3, 4, etc.) —Si—O-linkages. Useful aminoalkyl alkoxy silane compounds include substituents as described, with at least one substituent of a silicon atom being an aminoalkyl substituent bonded directly to the silicon atom or bonded to the silicon atom through a divalent oxygen (—O—) linkage, e.g., an aminoalkyl or aminoalkoxy substituent. See, e.g., U.S. Pat. No. 10,651,045; see also U.S. Pat. No. 8,940,182 and European Patent Application 0 498 458.

Examples of amino alkoxy silane compounds that contain only a single silicon atom can be represented as having the following formula:

Si(R1)(R2)(R3)(R4)

wherein each of R1, R2, R3, and R4 is an alkyl group, alkoxy group, hydroxyl group, an alkylamine group, or an alkoxyamine (aminoalkoxy) group, and wherein at least one of R1, R2, R3, and R4 is an alkyl, alkoxy, or hydroxyl group, and at least one of R1, R2, R3, and R4 is an alkylamine group or alkoxyamine group. An R1, R2, R3, or R4 group that includes an alkyl chain may include an alkyl chain that is branched, but straight chain groups can be preferred, as well as chains that contain lower alkyl groups such as an alkyl group having 1, 2, 3, 4, or 5 carbon atoms. Example R1, R2, R3, and R4 groups may be non-cyclic, saturated, and do not contain ether linkages. The amine-containing group can be any group that results in desired etching performance of the photoresist solution, including a useful combination of silicon nitride etch rate and silicon nitride selectivity. Some general examples of amine-containing groups of the amino alkoxy silane compounds include alkylamine groups that include a primary amine, i.e., a terminal amine; alkylamine groups that include a secondary or tertiary amine; and well as poly(ethyleneimine) oligomers and similar groups.

An amount of amino alkoxy silane (or a derivative thereof) contained in an etching solution can be an amount that in combination with the other materials of an etching solution will provide desired etching performance. For example, an etching solution can contain an amount of amino alkoxy silane compound, which may be a single species or a combination of two or more species, in an amount of up to 10 percent of the etching solution, for example in a range from about 20 to 50,000 parts per million (i.e., from 0.0020 to 5.0 weight percent) based on total weight of the etching solution, or from about 20 to 2,000, 4,000, or 5,000 parts per million (i.e., from 0.002 to 0.2, 0.4, or 0.5 weight percent) based on total weight of the etching solution.

Other ingredients may optionally also be useful in an etching solution to enhance silicon nitride selectivity or etch rate. These include, for example, organic solvent, hexafluorosilicic acid (HFCA), dissolved silica, phosphonic acid, and carboxylic acid compound. See, e.g., U.S. Pat. No. 10,651,045.

Hexafluorosilicic acid may be present in a useful amount, such as in a range from about 5 to 10,000 or even up to 50,000 parts per million (i.e., from 0.0005 to 1 or even 5 weight percent) based on total weight of the etching solution, e.g., from about 20 to 2,000 parts per million (i.e., from 0.002 to 0.2 weight percent) based on total weight of the etching solution.

Examples of useful carboxylic acid compounds include acetic acid, malonic acid, succinic acid, 2-methylsuccinic acid, glutaric acid, adipic acid, salicylic acid, 1,2,3-propanetricarboxylic acid (a.k.a. tricarballylic acid), 2-phosphonoacetic acid, 3-phosphonopropanoic acid, and 2-phosphonobutane-1,2,4-tricarboxylic acid (PBTCA), any of which may be used alone, in combination together with each other, or in combination with a different carboxylic acid compound. An etching solution may contain any useful amount of one or more carboxylic acid compounds, e.g., an amount in a range from about 0.01 to about 10 weight percent based on total weight of the etching solution, or from about 0.1 to about 5 or 8 weight percent based on total weight of the etching solution.

Methods and systems as described are useful for performing a quantitative determination of a concentration of amine-based inhibitor present in a sample of etching solution taken from a silicon nitride wet etch apparatus during a wet-etching operation, e.g., from a wet bath of a silicon nitride wet etch apparatus during a wet-etching operation. Example methods involve a spectroscopy method, which may be based on absorption spectroscopy, fluorescence spectroscopy, or both, to determine a concentration of amine-based inhibitor in an etching solution. A method does not directly measure a concentration of amine-based inhibitor itself in the etching solution but first forms a photosensitive chemical derivative or photosensitive group at amine groups of the amine-based inhibitor (the amine-based inhibitor compound that contains the photosensitive group is referred to as a “photosensitive inhibitor complex”). The method then detects the photosensitive group using a spectroscopy method to measure a concentration of the photosensitive inhibitor complex in the etching solution.

Absorption spectroscopy involves measuring an absorption of electromagnetic radiation as a function of frequency or wavelength (usually ultraviolet and visible (UV-Vis), based on an interaction of the electromagnetic radiation with a sample liquid. The sample liquid absorbs energy, e.g., photons, from a flux of electromagnetic radiation that is passed through the sample liquid. The level of absorption of radiation varies as a function of frequency and can also be correlated with an amount (concentration) of a specific radiation-absorbing solute in the sample.

Fluorescence spectroscopy (also known as fluorimetry or spectrofluorometry) is a type of spectroscopy that analyzes fluorescence from a sample. It involves using a beam of light, usually ultraviolet or visible light, that excites electrons in molecules of known compounds in a sample and causes the molecules to emit light, which is typically but not necessarily visible light. The intensity of light that fluoresces from a sample can be correlated with an amount (concentration) of a specific solute in the sample.

According to example methods, a concentration of amine-based inhibitor in an etching solution can be assessed by obtaining a sample of the etching solution (an “etching solution sample”) and preparing a test solution from the etching solution sample. Typically, the etching solution sample is at an elevated temperature, contains a concentrated amount of phosphoric acid solids, and is significantly viscous. The etching solution sample is not acceptable for analysis using a spectroscopy measurement. Accordingly, a test solution is prepared to have a reduced temperature compared to the etching solution sample, to contain a reduced concentration of phosphoric acid solids relative to the etching solution sample, and to have a reduced viscosity, to allow the test solution to be analyzed using a spectrometer and a spectroscopy method. The test solution can be prepared, for example, by reducing the temperature of the etching solution sample using a cooler, and diluting the etching solution sample with water (e.g., deionized water) at ambient temperature to prepare a test solution that has a reduced viscosity and a reduced concentration of phosphoric acid.

A complexing agent is also included in the test solution. The amine-based inhibitor is not photosensitive using spectroscopy techniques and is not detected directly according to the presently-described methods. Instead, a complexing agent is included in the test solution to chemically convert an amine group of the amine-based inhibitor into a photosensitive group such as photosensitive cyclic amine complex. A “photosensitive” group is a chemical compound or a chemical group that is detectable using a spectroscopy method, e.g., a chemical compound or a chemical group that will adsorb light or that will absorb light and release a different wavelength of light as does a chemical compound or group that fluoresces.

A “complexing agent” for use in a method as described is a chemical molecule that, alone or with a co-reactant, can be reacted with an amine group of an amine-based inhibitor of a test solution to form a photosensitive group from the amine group. The photosensitive group remains as part of the amine-based inhibitor and is capable of being detected by a spectroscopy method to determine a concentration of the amine-based inhibitor that contains the photosensitive group (“photosensitive inhibitor complex”), within the test solution.

Various complexing agents that are useful to form a photosensitive group from an amine group are known and are commercially available for reacting with an amine group of a larger molecule, optionally with a co-reactant, to form a photosensitive group that remain part of the larger molecule. Non-limiting examples include o-Phthaldialdehyde (“OPA”), 9-Fluorenylmethoxycarbonyl chloride (“9-Fluorenylmethyl chloroformate,” or “Fmoc-Cl”), Fluorescamine (3-(4-carboxybenzoyl) quinoline-2-carboxyaldehyde (CBQCA™)), ninhydrin, fluorescamin, dansyl chloride, phenylisothiocyanate (PITC), and 6-aminoquinolyl-N-hydroxysuccinimyl carbamate (AQC), though other useful examples are also known.

“Guide to Protein Purification,” 2nd Edition, James E. Noble, Marc J. A. Bailey, in Methods in Enzymology, 2009, describes amine-labeling “derivatization” using fluorescent probes as a technique to quantify amino acid mixtures in amino acid analysis. The technique can be used to quantify proteins and peptides that contain either lysine or a free N-terminus. Three probes that are identified as useful to quantify proteins or amino acids include o-phthalaldehyde (OPA) (Hammer and Nagel, 1986), Fluorescamine (Lorenzen and Kennedy, 1993), and 3-(4-carboxybenzoyl) quinoline-2-carboxyaldehyde (CBQCA™) (Asermely et al., 1997; Bantan-Polak et al., 2001; You et al., 1997). Fluorescamine reacts directly with an amine functional group, whereas OPA and CBQCA™ require the addition of a thiol (2-mercaptoethanol) or cyanide (CBQCA™) co-reactant.

OPA has the following structure:

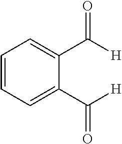

Ortho-phthalaldehyde (OPA) is a non-fluorescent compound that forms a fluorescent isoindole derivative in the presence of a primary amine and a free thiol moiety (which may be provided by, e.g., 2-mercaptoethanol co-reactant). The fluorescent complex is excited by UV light with a peak excitation wavelength of 340 nm, and emits light in the blue region of the visible spectrum, with a maximum at around 430 nm.

9-Fluorenylmethoxycarbonyl chloride has the following structure:

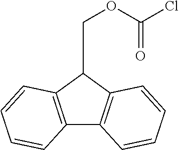 [SMILES: O=C(Cl)OCC1c2ccccc2-c2ccccc21]

A test solution may include a co-reactant as necessary for a complexing agent to react with an amine group to form a photosensitive group. When the complexing agent is OPA, the test solution also includes a thiol (e.g., 2-mercaptoethanol) as a co-reactant to form the photosensitive inhibitor complex. When the complexing agent is CBQCA™ the test solution includes cyanide as a co-reactant to form the photosensitive inhibitor complex.

A test solution may also include a buffer to control a pH of the test solution.

Once the test solution is prepared, the test solution is tested using a spectroscopy method to determine a concentration of the photosensitive inhibitor complex in the test solution, which can then be used to calculate the concentration of amine-based inhibitor in the test solution.

Determining a concentration of photosensitive inhibitor complex present in a test solution based on an absorption spectroscopy method includes passing light through the test solution and measuring the amount of light that becomes absorbed by the test solution. The amount of light that is absorbed by the test solution can be compared to an amount of light absorbed by one or more calibration solutions, e.g., in the form of a previously-generated calibration curve, to identify an amount (concentration) of the photosensitive inhibitor complex in the test solution. The concentration of photosensitive inhibitor complex in the test solution can be used to determine the amount of amine-based inhibitor in the etching solution sample that was used to prepare the test solution.

Determining a concentration of photosensitive inhibitor complex present in a test solution based on an fluorescence spectroscopy method includes passing light through the test solution and measuring the amount of light that fluoresces from the test solution. A beam of light that excites electrons in molecules of the photosensitive group of the photosensitive inhibitor complex causes the molecules to emit light, which is typically but not necessarily visible light. The intensity of light that fluoresces from a test solution can be compared to intensities of light that fluoresce from calibration solutions, e.g., in the form of a previously-generated calibration curve, to identify an amount (concentration) of the photosensitive inhibitor complex in the test solution. The concentration of photosensitive inhibitor complex in the test solution can be used to determine the amount of amine-based inhibitor in the etching solution sample that was used to prepare the test solution.

A process of monitoring a concentration of amine-based inhibitor in an etching solution of a silicon nitride wet-etching process can be performed using any useful and effective equipment and any steps or order of steps that are effective to obtain a sample of an etching solution (“etching solution sample”) from an etching bath of a silicon nitride wet-etching process during operation, and measuring a concentration of amine-based inhibitor in the etching solution by a method as described that includes a spectrometry method.

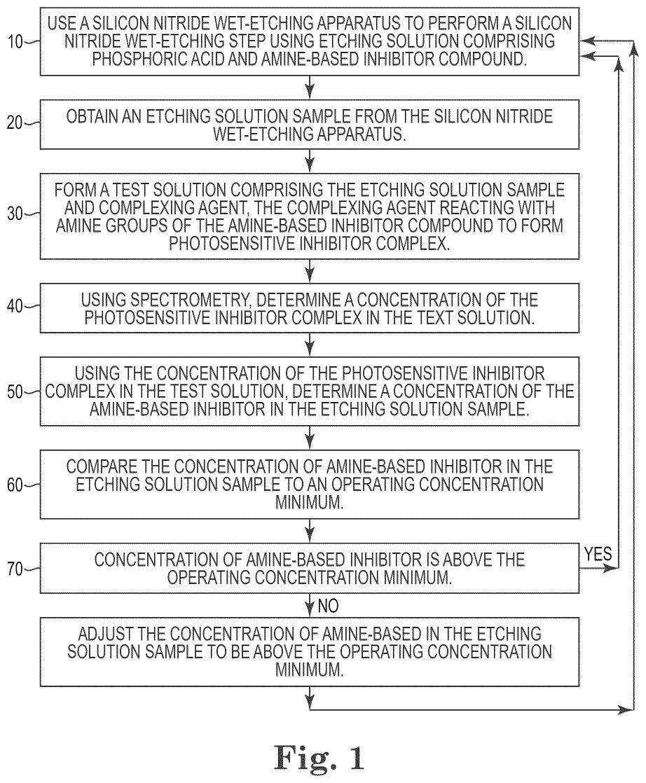

A useful example of a sequence of steps is shown schematically at FIG. 1. As illustrated, a silicon nitride wet-etching apparatus is used to perform a wet-etching step (10) on microelectronic device substrates that include a silicon nitride layer. While the etching apparatus is operating to perform the etching step, a sample of the etching solution (an “etching solution sample”) is obtained from the wet-etching apparatus (20), e.g., from a wet-etch bath. The etching solution sample can be cooled using a cooling device and then used to prepare a test solution (30) by combining the etching solution sample other ingredients that may include water, complexing agent, optional co-reactant, and buffer. The complexing agent reacts with an amine group of the amine-based inhibitor and optional co-reactant to produce a photosensitive group on the amine-based inhibitor (the resulting amine-based inhibitor with the photosensitive groups is referred to as a “photosensitive inhibitor complex”). The concentration of the photosensitive inhibitor complex in the test solution is measured using a spectroscopy method (40), and the measured concentration of photosensitive inhibitor complex is used to determine a concentration of the amine-based inhibitor in the etching solution sample (50).

The concentration of the amine-based inhibitor in the etching solution sample is compared to a pre-determined operating concentration range or a pre-determined operating concentration minimum (60) and is identified as being above or below the operating concentration minimum (70). If the concentration of the amine-based inhibitor above the operating concentration minimum, the silicon nitride wet-etching process can continue to be performed in the silicon nitride wet-etching apparatus. If the concentration of the amine-based inhibitor is below the operating concentration minimum, the composition of the etching solution is adjusted to contain a concentration of amine-based inhibitor that is above the operating concentration minimum, such as by partially or completely replacing the etching solution in the apparatus.

Specifically with respect to step 30 of forming a test solution that includes the etching solution sample and the complexing agent (and optional co-reactant and buffer) to form the photosensitive inhibitor complex, certain steps and precautions may be useful or desired for preparing a test solution that is suitable for analysis using a spectrometry method. For example, the etching solution sample contains a high concentration of phosphoric acid solids and will be at a high temperature (may typically have a temperature of at least 100, 130, or 150 degrees Celsius) and have a significant viscosity when removed from the wet-etching apparatus. According to example methods, the etching solution sample can be diluted with water, e.g., deionized water having a lower temperature, such as at room temperature (e.g., from 20 to 23 degrees Celsius).

Diluting the etching solution sample with deionized water accomplishes multiple functions. One function is to prepare a test solution that has a viscosity and phosphoric acid concentration suitable for analysis of the test solution using a spectroscopy method. An additional function can be to dilute the concentration of amine-based inhibitor to a range that is reduced compared to the concentration of amine-based inhibitor in the etching solution sample. Spectroscopy methods for measuring concentrations of a solute (e.g., photosensitive inhibitor complex) in solution (e.g., a test solution) are adapted to determine concentration levels that are in within certain concentration ranges. The etching solution sample can be diluted with water to form a test solution that contains the amine-based inhibitor (converted to a photosensitive inhibitor complex) in a range that can be effectively measured using a spectroscopy method.

In example steps (30) of preparing a test solution, a known volume of the etching solution sample can be combined (diluted) with a known volume of deionized water to form a test solution that has a temperature of approximately ambient temperature and a concentration of amine-based inhibitor that upon being converted to a photosensitive inhibitor complex will allow for accurate measurement of the concentration of photosensitive inhibitor complex in the test solution. The test solution also has a viscosity and a concentration of phosphoric acid solids that are acceptable for a sample being analyzed using a spectroscopy technique and equipment.

The volume of the etching solution sample can be as desired, with example volumes being up to 20 milliliters, e.g., in a range from 0.001 to 10 milliliters. The volume of deionized water that can be combined with the etching solution sample can be a volume useful to produce a useful test solution as described, for example a volume of deionized water that is at least 100 times the volume of the etching solution sample, e.g., a volume of deionized water in a range from 100 to 500 times the volume of the etching solution sample.

The amount of complexing agent that is included in the test solution can be any useful amount, for example an amount that provides a stoichiometric excess of the complexing agent relative to amine groups of the amine-based inhibitor. The complexing agent can be added alone, or in combination with an amount of water, and optionally in combination with buffer.

Other ingredients such as a co-reactant useful to react a complexing agent with an amine group of an amine-based inhibitor may also be included in the test solution. For example, a test solution that contains OPA as a complexing agent may include a thiol (e.g., 2-mercaptoethanol) as a co-reactant for forming the photosensitive inhibitor complex. A test solution that contains CBQCA™ as a complexing agent may include cyanide as a co-reactant to form the photosensitive inhibitor complex. Any required co-reactant can be included in the test solution in an amount that provides a stoichiometric excess of the co-reactant relative to amine groups of the amine-based inhibitor.

A pH buffer can be included in the test solution to produce a desired pH of the test solution to control pH. A desired pH range may depend on the type of amine-based inhibitor or the complexing agent, with an example pH range useful for either OPA or FMOC complexing agent being in a range from 9 to 11. Importantly, while a range of pH may be useful to measure a concentration of amine-based inhibitor in a test solution, the pH of different test solutions and of relevant calibration solutions should be the same, to achieve useful comparisons.

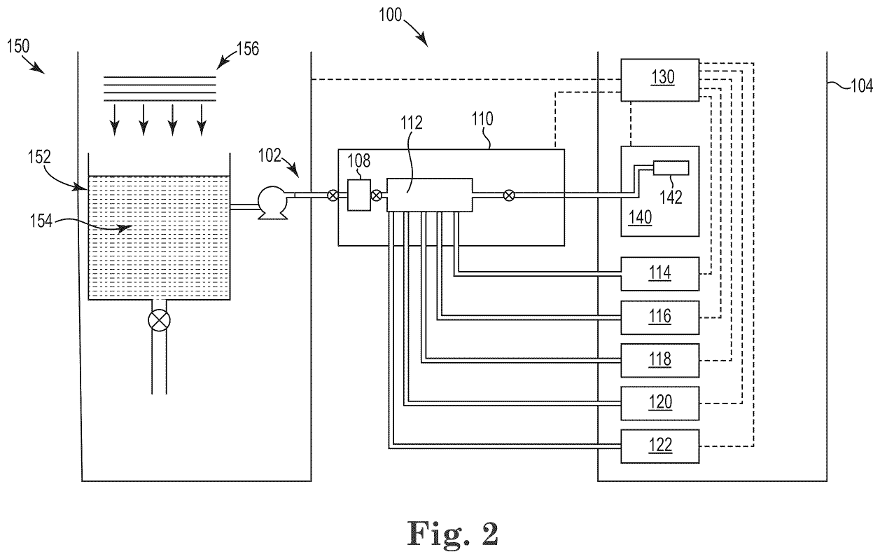

An example automated fluid monitoring system for monitoring a concentration of amine-based inhibitor in an etching solution is shown at FIG. 2. System 100 is an automated system for monitoring a concentration of amine-based inhibitor in an etching solution and is operationally connected to wet-etching apparatus 150. Wet-etching apparatus 150 includes wet-etching bath 152 that contains etching solution 154, which is a phosphoric acid etching solution that also contains amine-based inhibitor and other optional ingredients as described herein. Semiconductor wafers (substrates) 156 can be placed into etching solution 154 in bath 152 for an etching step that removes silicon nitride, e.g., that selectively removes silicon nitride from surfaces of semiconductor wafers that contain both silicon nitride and silicon oxide.

Wet-etching apparatus 150 is operationally connected to system 100, including through sampling connection 102. Sampling connection 102 includes a closed fluid connection that allows a sample of etching solution 154 (“etching solution sample”) to be removed from bath 152 and passed through connection 102 to system 100, e.g., using one or more pumps, valves, and control devices to obtain and transfer a specific volume of the etching solution sample.

Example system 100 includes control module 104 and test solution module 110. These are illustrated as being two individual (separate) modules with test solution module 110 being physically separated (or “remote”) from control module 104. Alternately, the two modules may be integrated. As illustrated with test solution module 110 being separate from control module 104, test solution module 110 can be designed and structured as a temperature-rated module that is physically adapted to receive and handle an etching solution sample received from bath 152 at a relatively high temperature and with a high concentration of phosphoric acid. Separating test module 110 from control module 104 can prevent exposing the other components of control module 110 to the high temperature and concentrated phosphoric acid of the etching solution sample.

Control module 104 contains multiple fluid reservoirs that as illustrated may include: deionized water reservoir 114, complexing agent reservoir 116, co-reactant module 118, and buffer module 120. Each of reservoirs 114, 116, 118, and 120 is adapted to supply a desired amount of a different liquid (deionized water, complexing agent, co-reactant, buffer) to the test solution module, with control and sensor devices adapted to control a volume and rate of each flow of a fluid.

Control module 104 also includes control system 130, and a spectrometer or fluorometer 142 for measuring a concentration of a solute (photosensitive inhibitor complex) in a test solution using a spectroscopy method and control system 130.

Control module 104 also includes reservoir 122, containing one or more calibration solutions. In use, control module 104 and reservoir 122 are adapted to supply an amount of one or more calibration solutions to the test solution module for performing a step of calibrating spectrometer 142.

Control system 130 is operationally (e.g., electronically) connected to each of: wet-etching apparats 150 and its various components, test solution module 110 and its various components, spectrometer 142, and each of reservoirs 114, 116, 118, 120, and 122, including relevant control devices (e.g., valves and pumps), sensors, and flow control devices associated with each (not specifically shown) to monitor and control conditions of each component and flows (volumes, rates) of fluids between each component.

Not specifically shown at FIG. 2 are various sensors and control devices (e.g., valves, flow meters, sensors, etc.) that are included as part of etching apparatus 150, test module 110, system 100, and control system 130, and their related components, which are used in a step of measuring a concentration of amine-based inhibitor in an etching solution sample obtained from bath 152. Sensors and control devices can be adapted to measure, monitor, or control one or more of the temperature and flow (volume, rate) of fluids of etching apparats 150 and system 100 (including fluids of reservoirs 114, 116, 118, 120, and 122), in cooperation with at least a computerized hardware processor and memory device of control system 130. The memory device can store instructions to be executed at the processor in response to electronic signals indicative of measured values, conditions, or inputs received from etching apparatus 150, system 100, or a component of one of these. According to various examples, control system 130 can include a computer processor a microprocessor of any form, e.g., a process logic controller (PLC controller) embodied in an application-specific integrated circuit (ASIC), or the like.

Test solution module 110 includes mixing chamber 112, which is connected to bath 152 and adapted to receive the etching solution sample of etching solution 154 from bath 152 through sampling connection 102. Cooling device 108 receives a sample of etching solution 154, which is at an elevated temperature, and reduces the temperature of the sample for forming a test solution in mixing chamber 112. Test solution module 110 is also connected to fluid reservoirs of control module 104 to receive fluids required to form a test solution in mixing chamber 112 by combining the etching solution sample with one or more fluids from the fluid reservoirs, e.g., deionized water, complexing agent, buffer, and optional co-reactant.

While FIGS. 1 and 2 show a system and method steps that are specifically adapted to measure concentrations of amine-based adsorbent in an etching solution during use of the etching solution in a wet etch process and at an elevated temperature, comparable steps are useful for measuring a concentration of amine-based inhibitor in an etching solution at a different time or at a lower temperature. For example, the described method and system may be useful to measure a concentration of amine-based inhibitor in an etching solution before the etching solution is used in the etching process, while the etching solution is at room temperature. These methods do not require a step of cooling the etching solution prior to or during the step of forming the test solution.

The described spectrometry methods, using either absorbent spectrometry or fluorescence spectrometry, may require calibration of the spectrometer using one or more calibration solutions (contained at reservoir 122) that each contain a known concentration of amine-based inhibitor.

A calibration solution may be a solution that includes a known concentration of phosphoric acid and amine-based inhibitor comparable to etching solution 154. One or more calibration solutions may be used to perform a calibration step of spectrometer 142 by: delivering a known volume of the calibration solution (having a known concentration of amine-based inhibitor) to mixing chamber 112, combining the volume of calibration solution with ingredients as described (e.g., deionized water, complexing agent and optional co-reactant, and buffer) to form a test solution, measuring absorbance or fluorescence of the test solution using spectrometer 142, and correlating the absorbance or fluorescence of the test solution to the known concentration of amine-based inhibitor in the calibration solution.

From absorbance of fluorescence measurements performed on multiple calibration solutions having different known concentrations of amine-based inhibitor, system 100, e.g., using software of control system 130, can produce a calibration curve that relates a measured absorbance or fluorescence value to a concentration of amine-based inhibitor in a calibration solution. A measured absorbance or fluorescence value of a test solution prepared from a sample etching solution obtained from an etching bath of an operating wet-etching operation (150) can be compared to the calibration curve to determine a concentration of amine-based inhibitor in the sample etching solution.

1. A method of determining a concentration of amine-based inhibitor in a silicon nitride etching solution, the method comprising:
preparing a test solution comprising silicon nitride etching solution, complexing agent, and water, the silicon nitride etching solution comprising phosphoric acid and amine-based inhibitor,
allowing the complexing agent to react with an amine group of the amine-based inhibitor to form a photosensitive inhibitor complex,
using spectroscopy to determine a concentration of the photosensitive inhibitor complex in the test solution, and
from the concentration of the photosensitive inhibitor complex in the test solution, determining a concentration of the amine-based inhibitor in the etching solution.

2. The method of claim 1, comprising:
while exposing the test solution to radiation, determining an absorbance value of the test solution, and
using the absorbance value of the test solution to determine a concentration of the photosensitive inhibitor complex in the test solution, and
from the concentration of the photosensitive inhibitor complex in the test solution, determining a concentration of the amine-based inhibitor in the etching solution.

3. The method of claim 2, comprising comparing the absorbance value to absorbance values of calibration solutions.

4. The method of claim 1, comprising:
while exposing the test solution to radiation, determining a fluorescence intensity of the test solution, and
using the fluorescence intensity of the test solution to determine a concentration of the photosensitive inhibitor complex in the test solution, and
from the concentration of the photosensitive inhibitor complex in the test solution, determining a concentration of the amine-based inhibitor in the etching solution.

5. The method of claim 4, comprising comparing the fluorescence intensity of the test solution value to absorbance values of calibration solutions.

6. The method of claim 1, wherein the amine-based inhibitor comprises an aminoalkyl silane compound or an aminoalkoxy silane compound.

7. The method of claim 1, wherein the complexing agent comprises ortho-phthalaldehyde, 9-fluorenylmethoxycarbonyl chloride, or fluorescamine (3-(4-carboxybenzoyl) quinoline-2-carboxyaldehyde).

8. The method of claim 1, wherein preparing the test solution comprises combining one volume etching solution with at least 100 volumes deionized water.

9. The method of claim 1, comprising:
obtaining an etching solution sample from a silicon nitride wet-etching apparatus that includes a silicon nitride etching bath, the etching solution sample having a volume in a range from 0.001 to 20 milliliters, the etching solution sample having a temperature of at least 150 degrees Celsius,
combining one volume etching solution sample with at least 100 volumes deionized water.

10. The method of claim 1, further comprising:
obtaining an etching solution sample from a silicon nitride wet-etching apparatus that includes a silicon nitride etching bath, the etching solution sample having a volume in a range from 0.001 to 20 milliliters, the etching solution having a temperature of at least 150 degrees Celsius,
forming a test solution comprising:
the etching solution,
at least 100 volumes deionized water per one volume etching solution,
pH buffer, and
complexing agent;
allowing the complexing agent to react with an amine group of the amine-based inhibitor to form a photosensitive inhibitor complex,
placing the test solution within spectrometer,
passing electromagnetic radiation through the test solution,
analyzing intensity of light that exits the analysis cell, and
from the intensity of the light that exits the analysis cell, determining a concentration of the amine-based inhibitor in the etching solution.

11. The method of claim 1, performed using an automated fluid monitoring system that is operatively connected to a silicon nitride wet-etching apparatus, the automated fluid monitoring system comprising:
(a) a sampling system adapted to retrieve an etching solution sample from a silicon nitride wet-etching apparatus that includes a silicon nitride etching bath,
(b) a reservoir of deionized water,
(c) a reservoir of pH buffer solution,
(d) a reservoir of complexing agent,
(e) a mixing chamber adapted to prepare a test solution comprising at least a portion of the etching solution sample, deionized water, pH buffer, and complexing agent, and to allow the complexing agent to react with an amine group of amine-based inhibitor contained in the etching solution sample to form a photosensitive inhibitor complex,
(f) a spectrometer adapted to receive the test solution from the mixing chamber and measure a concentration of photosensitive inhibitor complex in the test solution, and
(g) a control system adapted to determine a concentration of amine-based inhibitor in the etching solution sample based on the measured concentration of photosensitive inhibitor complex in the test solution.

12. An automated fluid monitoring system adapted to monitor a concentration of amine-based inhibitor in an etching solution, the system comprising:
(a) a sampling system adapted to obtain an etching solution sample from a silicon nitride wet-etching apparatus that includes a silicon nitride etching bath,
(b) a reservoir of deionized water,
(c) a reservoir of pH buffer solution,
(d) a reservoir of complexing agent,
(e) a mixing chamber adapted to prepare a test solution comprising at least a portion of the etching solution sample, deionized water, pH buffer, and complexing agent, and to allow the complexing agent to react with an amine group of amine-based inhibitor contained in the etching solution sample to form a photosensitive inhibitor complex,
(f) a spectrometer adapted to receive the test solution from the mixing chamber and measure a concentration of photosensitive inhibitor complex in the test solution, and
(g) a control system adapted to determine a concentration of amine-based inhibitor in the etching solution sample based on the concentration of photosensitive inhibitor complex in the test solution.

13. The system of claim 12, wherein the control system compares the concentration of amine-based inhibitor in the etching solution to a pre-determined concentration minimum.

14. The system of claim 12, wherein the sampling system comprises a fluid connection that allows the etching solution sample to be delivered from the silicon nitride wet-etching apparatus to the mixing chamber.

15. The system of claim 12, wherein the amine-based inhibitor comprises an aminoalkyl silane compound or an aminoalkoxy silane compound.

16. The system of claim 12, wherein the complexing agent comprises ortho-phthalaldehyde, 9-fluorenylmethoxycarbonyl chloride, or fluorescamine (3-(4-carboxybenzoyl) quinoline-2-carboxyaldehyde).

17. The system of claim 12, comprising a control module and a remote test solution module, wherein:
the control module contains: the reservoir of deionized water, the reservoir of pH buffer solution, the reservoir of complexing agent, the spectrometer, and the control system, and
the remote test solution module contains the mixing chamber with a fluid connection to each of: the silicon nitride etching bath, the reservoir of deionized water, the reservoir of pH buffer solution, the reservoir of complexing agent, and the spectrometer.

18. A method of determining a concentration of amine-based inhibitor contained in a liquid, the method comprising:
forming a photosensitive group from an amine group of amine-based inhibitor in a liquid, and
using a spectroscopy method to measure a concentration of the amine-based inhibitor having the photosensitive group, in the liquid.

19. The method of claim 18, wherein the liquid comprises silicon nitride etching solution that contains phosphoric acid and the amine-based inhibitor.

20. The method of claim 19, wherein the liquid is a test solution comprising the silicon nitride etching solution and deionized water.

21. The method of claim 18, wherein the photosensitive group is a cyclic amine group.

22. A method of forming a photosensitive compound in a liquid, the method comprising:
preparing a solution comprising:
phosphoric acid,
amine-based inhibitor comprising an amine group,
complexing agent, and
water,
allowing the complexing agent to react with the amine group to form a photosensitive inhibitor complex.

23. The method of claim 22, wherein the amine-based inhibitor comprises an aminoalkyl silane compound or an aminoalkoxy silane compound.

24. The method of claim 22, wherein the complexing agent comprises ortho-phthalaldehyde, 9-fluorenylmethoxycarbonyl chloride, or fluorescamine (3-(4-carboxybenzoyl) quinoline-2-carboxyaldehyde).
